(19) United States
(12) Patent Application Publication
(10) Pub. No.: US 2025/0135711 A1
(43) Pub. Date: May 1, 2025

(54) METHOD FOR MANUFACTURING A STIFFENED PANEL MADE OF COMPOSITE MATERIAL COMPRISING A STEP OF LAYING A SKIN THEN A STEP OF LAYING PROFILES, AND TOOL FOR IMPLEMENTING SAID METHOD

(71) Applicant: Airbus SAS, BLAGNAC (FR)

(72) Inventors: Jago PRIDIE, ROCHEFORT (FR); Maxime PERCEVAULT, ROCHEFORT (FR)

(21) Appl. No.: 18/911,357

(22) Filed: Oct. 10, 2024

(30) Foreign Application Priority Data
Oct. 25, 2023 (FR) 2311619

(51) Int. Cl. B29C 51/12; B29C 51/18; B29C 51/30; B29C 51/42; B29C 51/46; B29L 7/00; B29L 31/30; E04C 2/38

(52) U.S. Cl. CPC B29C 51/12; B29C 51/18; B29C 51/303; B29C 51/428; B29C 51/46; E04C 2/38; B29L 2007/002; B29L 2031/3085

(57) ABSTRACT

A method for manufacturing a stiffened panel, obtained from profiles and a skin, comprising a step of obtaining the profiles and of positioning each of the profiles on a mandrel, a step of laying the skin on a laying surface of a mold and then a step of laying the mandrels on the skin, the bases of the profiles being positioned against the skin, as well as a step of polymerizing or consolidating the profiles and the skin to obtain a stiffened panel. Also a tool for implementing such a method.

### CROSS-REFERENCES TO RELATED APPLICATIONS

This application claims the benefit of French Patent Application Number 2311619 filed on Oct. 25, 2023, the entire disclosure of which is incorporated herein by way of reference.

### FIELD OF THE INVENTION

The present application relates to a method for manufacturing a stiffened panel made of composite material comprising a step of laying a skin and then a step of laying profiles, as well as to a tool for implementing said method.

### BACKGROUND OF THE INVENTION

According to an embodiment visible in FIG. 1, a stiffened panel 10 comprises a wall 12 which has first and second faces 12.1, 12.2 as well as a plurality of stiffening members 14 substantially parallel (i.e., +/−10%) to each other, perpendicular to the wall 12 and positioned on the first face 12.1.

According to an operating method visible in FIGS. 2A to 2C, a method for manufacturing a stiffened panel made of composite material comprises a step of manufacturing U-shaped or L-shaped profiles 16 made of composite material, a step of laying mandrels 18, each supporting a profile 16, on a laying surface 20, as illustrated in FIG. 2A, the bases 16.1 of the profiles 16 being substantially parallel to the laying surface 20 and spaced apart from the latter, a step of laying a skin 22 made of composite material on the bases 16.1 of the profiles 16, as illustrated in FIG. 2B, a step of installing a polymerization or consolidation tool 24, as illustrated in FIG. 2C, and a polymerization or consolidation step.

According to one embodiment, each U-shaped profile is obtained by draping plies of fibers flat to form a flat preform and then by deforming the flat preform on a mold so as to fold the two flanges 16.2, 16.3 of the U-shaped profile 16.

According to one arrangement, each mandrel 18 comprises an upper face 18.1 against which the base 16.1 of a U-shaped profile 16 is positioned, a lower face 18.2 (parallel to the upper face 18.1) in contact with the laying surface 20 as well as right-and left-hand lateral faces against which the flanges 16.2, 16.3 of the profile 16 are positioned.

The various mandrels 18 are laid on the laying surface 20 and are joined to one another in order to press a first flange 16.2 of a profile 16 of a first mandrel 18 against a second flange 16.3 of a profile 16 of a second mandrel 18, the first and second flanges 16.2, 16.3 forming, after the polymerization or consolidation step, a stiffening member 14 of the stiffened panel 10.

According to one embodiment, the skin 22 is obtained by successively depositing several plies of fibers. After the polymerization or consolidation step, the skin 22 and the bases 16.1 of the profiles 16 form the wall 12 of the stiffened panel 10.

According to an embodiment visible in FIG. 3, the polymerization or consolidation tool 24 comprises a caul plate 24.1 attached to the skin 22, various shims 24.2 positioned on the two sides of the mandrels 18 and of the skin 22, at least one drainage layer 24.3 covering the caul plate 24.1 and the shims 24.2, and a sealed bladder 24.4 covering the drainage layer 24.3, sealingly connected to the laying surface 20 by at least one sealing system 24.5, entirely surrounding the mandrels 18 and the shims 24.2.

### SUMMARY OF THE INVENTION

This embodiment is not entirely satisfactory because the polymerization or consolidation tool 24 is relatively complex and requires a relatively long installation time.

In order to obtain a satisfactory surface finish on the second face 12.2 of the stiffened panel 10, the polymerization or consolidation tool 24 comprises a caul plate 24.1. The use of a caul plate 24.1 applied against the second face 12.2 of the stiffened panel 10 is not entirely satisfactory because it requires a significant cleaning phase at the end of the polymerization or consolidation step.

The present invention is intended to overcome some or all of the drawbacks in the prior art.

For this purpose, the invention relates to a method for manufacturing a stiffened panel obtained from profiles each having a base and at least one flange and a skin having first and second faces, the bases of the profiles being pressed against the first face of the skin, the flanges of the profiles being pressed together in pairs, the manufacturing method comprising a step of obtaining the profiles and of positioning each of the profiles on a mandrel as well as a step of polymerizing or consolidating the profiles and the skin to obtain a stiffened panel.

According to the invention, before the polymerization or consolidation step, the manufacturing method comprises a step of laying the skin on a laying surface of a mold, the second face of the skin being pressed against the laying surface, as well as a step of laying the mandrels on the skin, the bases of the profiles being positioned against the skin.

The fact that the skin from which the stiffened panel is obtained is positioned against the mold obviates the need for the caul plate and shortens the cleaning time at the end of the polymerization or consolidation step. Moreover, positioning the skin and the bases of the profiles between the mold and the mandrels allows the mandrels to be used as a sealing barrier and simplifies the latter.

According to another feature, the mold comprises a seat in which at least the skin is positioned.

According to another feature, the manufacturing method comprises, before the polymerization or consolidation step, a step of laying a sealing barrier designed to form, with at least the mold, a substantially sealed enclosure in which the skin and the profiles are positioned.

According to another feature, the manufacturing method comprises a step of laying a frame around the mandrels in order to immobilize them with respect to the mold, said frame being sealingly connected to the mold, and a step of laying a rigid plate sealingly connected to the frame to form the sealing barrier.

According to another feature, prior to the step of laying the mandrels, the seat being delimited by a peripheral edge and dimensioned to leave a gap between the skin and the peripheral edge, the manufacturing method comprises a step of laying a packing shim to fill the gap between the skin and the peripheral edge of the seat.

The invention also relates to a polymerization or consolidation tool for implementing a method according to one of the features set out above. According to the invention, the polymerization or consolidation tool comprises several mandrels each designed to receive a profile and a mold including a seat delimited by a bottom and a peripheral edge, said seat being designed to receive at least one skin, said bottom forming a laying surface on which the skin is laid.

According to another feature, the tool comprises a sealing barrier forming, with at least the mold, a substantially sealed enclosure in which the skin and the profiles are positioned.

According to another feature, the tool comprises a frame designed to be positioned around the mandrels and to immobilize them with respect to the mold. Additionally, the sealing barrier comprises a rigid plate which has a peripheral edge overlapping the frame, at least one first gasket interposed between the mold and the frame, and at least one second gasket interposed between the frame and the rigid plate.

According to another feature, the tool comprises:
first and second end mandrels between which all the other mandrels are positioned, each of the first and second end mandrels having an inclined free lateral end face, the lateral end faces moving apart as they approach the laying surface,
a clamping system comprising at least first and second flanges, positioned on the two sides of the mandrels, which have first and second contact faces in contact with the two lateral end faces, respectively, the first and second contact faces moving apart as they approach the laying surface.

According to another feature, the first and second flanges are connected together so as to form the frame.

According to another feature, the clamping system comprises, for each first or second flange, a tightening system designed to connect the first or second flange to the mold and to gradually bring it closer to the mold.

According to another feature, the clamping system comprises, for each first or second flange, a guide system designed to guide the first or second flange relative to the mold in a direction substantially perpendicular to the laying surface.

According to another feature, the tool comprises at least one packing shim designed to fill a gap between the skin and the peripheral edge of the seat.

According to another feature, the tool comprises at least one temperature regulation system for at least one mandrel and/or for the mold.

### BRIEF DESCRIPTION OF THE DRAWINGS

Other features and advantages will become apparent from the following description of the invention, the description being given solely by way of example and with reference to the appended drawings, in which:

FIG. 1 is a perspective view of a stiffened panel,

FIG. 2A is a schematic representation of a first step for manufacturing a stiffened panel illustrating an embodiment of the prior art,

FIG. 2B is a schematic representation of a first step for manufacturing a stiffened panel illustrating an embodiment of the prior art,

FIG. 2C is a schematic representation of a first step for manufacturing a stiffened panel illustrating an embodiment of the prior art,

FIG. 3 is a schematic cross section of a polymerization or consolidation tool illustrating an embodiment of the prior art,

FIG. 4 is a schematic cross section of a polymerization or consolidation tool illustrating an embodiment of the invention,

FIG. 5 is a cross section of a polymerization or consolidation tool illustrating another embodiment of the invention,

FIG. 6 is a cross section of a polymerization or consolidation tool illustrating another embodiment of the invention,

FIG. 7 is a cross section of a part of the polymerization or consolidation tool visible in FIG. 5 after a step of laying a skin of a stiffened panel,

FIG. 8 is a cross section of a part of the polymerization or consolidation tool visible in FIG. 5 after a step of laying mandrels, each supporting one profile,

FIG. 9 is a cross section of a part of the polymerization or consolidation tool after a mandrel clamping step,

FIG. 10 is a cross section of a part of the polymerization or consolidation tool during a step of laying a rigid plate of a sealing barrier,

FIG. 11 is a schematic cross section of a polymerization or consolidation tool illustrating another embodiment of the invention.

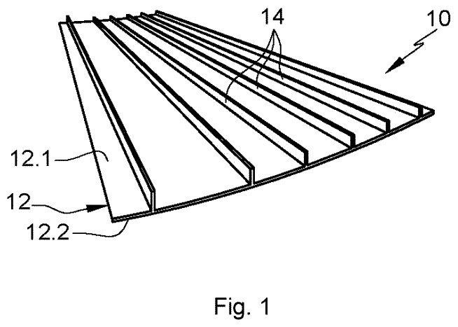

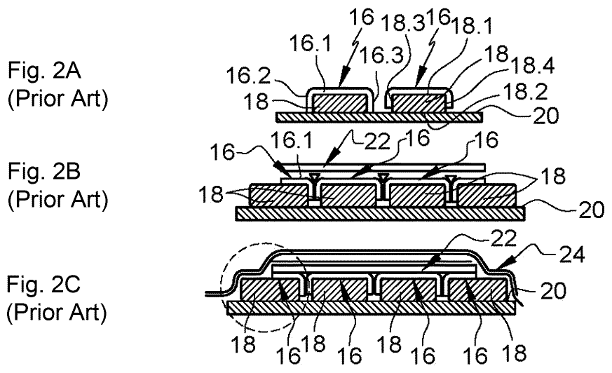

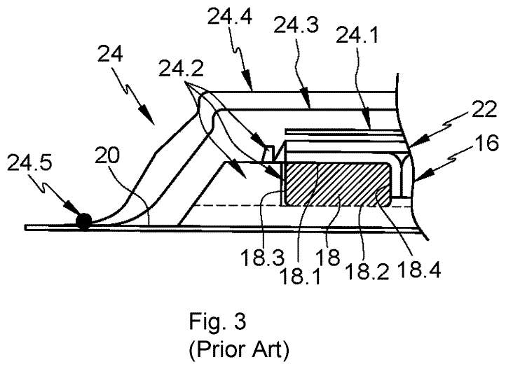

### DETAILED DESCRIPTION OF THE PREFERRED EMBODIMENTS

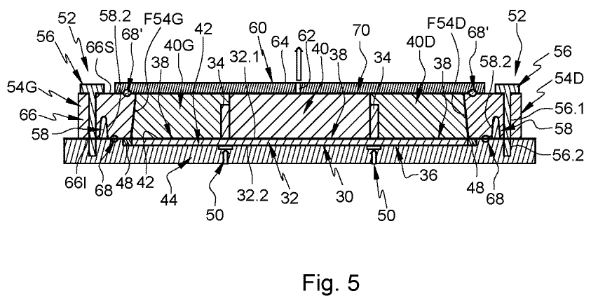

As illustrated in FIG. 5, a stiffened panel 30 made of composite material comprises a wall 32 which has first and second faces 32.1, 32.2 as well as several stiffening members 34 substantially parallel to each other, perpendicular to the wall 32 and positioned on the first face 32.1 of the wall 32.

According to one application, an aircraft and more particularly a central wingbox of an aircraft comprise at least one such stiffened panel 30.

In the remainder of the description, a longitudinal direction is parallel to the stiffening members 34. A length corresponds to a dimension measured parallel to the longitudinal direction. A transverse plane is a plane perpendicular to the longitudinal direction.

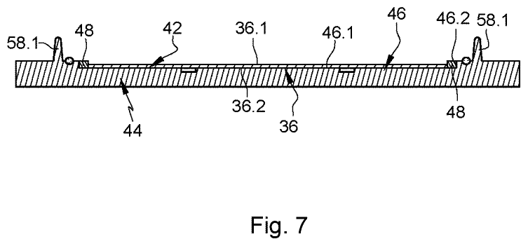

This stiffened panel 30 is obtained from a skin 36 (visible in FIG. 7) which has first and second faces 36.1, 36.2 as well as several profiles 38 each having a base 38.1 and at least one flange 38.2. According to one arrangement, at least one profile 38 has a U-shaped section and comprises two flanges 38.2, 38.3 positioned on the two sides of the base 38.1.

The bases 38.1 of the profiles 38 are pressed against the first face 36.1 of the skin 36 and form with the latter the wall 32, the second face 36.2 of the skin 36 forming the second face 32.2 of the wall 32. Additionally, the flanges 38.2, 38.3 of the profiles 38 are pressed together in pairs, one against the other, to form a stiffening member 34.

The method for manufacturing a stiffened panel 30 comprises a step of manufacturing profiles 38, in particular U-shaped or L-shaped profiles. This step is not described further because it can be identical to the prior art.

The method for manufacturing the stiffened panel 30 comprises a step of laying the skin 36 on a laying surface 42, the second face 36.2 of the skin 36 being pressed against the laying surface 42, a step of laying the profiles 38 on the skin 36, the bases 38.1 of the profiles 38 being positioned against the skin 36, then a polymerization or consolidation step during which the skin 36 and the profiles 38 are polymerized or consolidated so as to obtain the stiffened panel 30 using a polymerization or consolidation tool.

This polymerization or consolidation tool comprises several mandrels 40, each receiving a profile 38. Each mandrel 40 has a square or rectangular cross section and comprises a first face 40.1 against which the base 38.1 of a profile 38 is positioned, a second face 40.2 substantially parallel to the first face 40.1 and right-and left-hand lateral faces 40.3, 40.4, against at least one of which a flange 38.2 of the profile 38 is positioned (visible in FIG. 7). In the case of a U-shaped profile 38 with two flanges 38.2, 38.3, each flange is positioned against one of the right-and left-hand lateral faces 40.3, 40.4 of a mandrel 40.

The mandrels 40 are not described further since they can be identical to the prior art.

When the mandrels 40 provided with profiles 38 are positioned on the skin 36, the first and second faces 40.1, 40.2 thereof as well as the right-and left-hand lateral faces 40.3, 40.4 thereof are substantially parallel to the longitudinal direction.

According to one operating method, during the step of laying the skin 36, plies are stacked on top of one another on the laying surface 42 so as to obtain the skin 36. According to another operating method, the skin 36 is in the form of a preform deposited as a block on the laying surface 42.

According to one embodiment, the polymerization or consolidation tool comprises a mold 44 which has a laying surface 42. This mold 44 comprises a seat 46 in which at least the skin 36 is positioned. This seat 46 has a bottom 46.1 which forms the laying surface 42 as well as a peripheral edge 46.2.

According to an arrangement visible in FIG. 5, the seat 46 is dimensioned to leave a small gap of the order of a few millimeters between the skin 36 and the peripheral edge 46.2. Additionally, the polymerization or consolidation tool comprises at least one packing shim 48 designed to fill the gap between the skin 36 and the peripheral edge 46.2 of the seat.

Prior to the step of laying the mandrels 40, the seat 46 being delimited by a peripheral edge 46.2 and dimensioned to leave a small gap between the skin 36 and the peripheral edge 46.2, the manufacturing method comprises a step of laying a packing shim 48 to fill the gap between the skin 36 and the peripheral edge 46.2 of the seat 46.

According to one embodiment, the seat 46 is designed to receive the skin 36 only. In this case, the height of the peripheral edge 46.2 is substantially equal to the thickness of the skin 36.

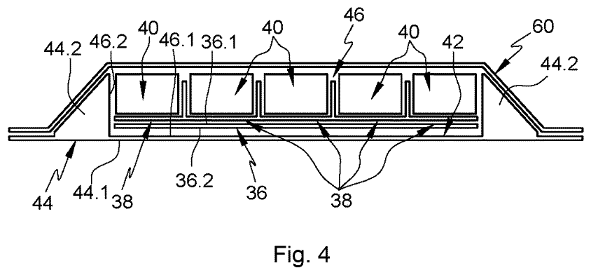

According to a second embodiment visible in FIG. 4, the seat 46 is designed to receive the skin 36, the profiles 38 and the mandrels 40.

According to this second embodiment, the mold 44 comprises a base 44.1 and a frame 44.2, made in one piece and delimiting the seat 46, the base 44.1 forming the bottom 46.1 of the seat 46, the frame 44.2 forming the peripheral edge 46.2 of the seat 46.

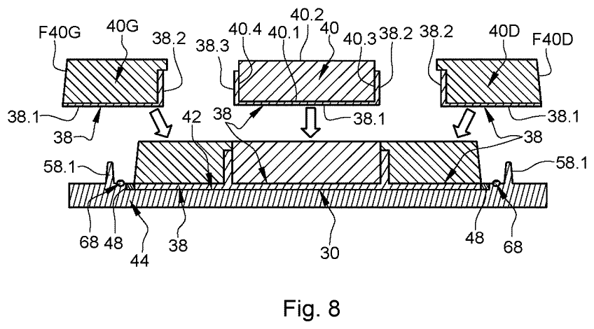

According to a third embodiment visible in FIG. 8, the seat 46 is designed to receive the skin 36 and the bases 38.1 of the profiles. In this case, the height of the peripheral edge 46.2 is substantially equal to the thickness of the wall 32, i.e. approximately the sum of the thicknesses of the skin 36 and of the bases 38.1 of the profiles 38.

Positioning the skin 36 against the mold 44 obviates the need for a caul plate and shortens the cleaning time at the end of the polymerization or consolidation step. Moreover, positioning the skin 36 and the bases 38.1 of the profiles 38 between the mold 44 and the mandrels 40 enables the mandrels 40 to be used as a sealing barrier. Arranging the mandrels 40 in sealing contact with each other and with the mold 44 obviates the need for a sealing barrier. If a sealing barrier is used, it can be simplified.

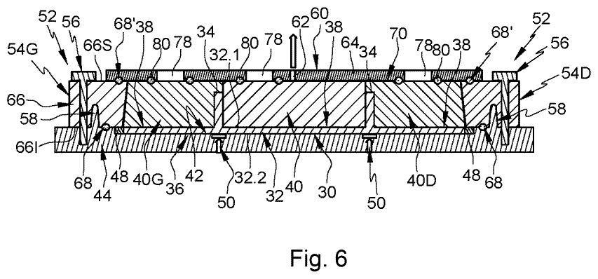

As shown in FIGS. 5 and 6, the mold 44 comprises at least one extractor 50 designed to be in a retracted state in which it does not project from the laying surface 42 and an extended state in which it projects from the laying surface 42 and pushes the obtained stiffened panel 30 out of the mold 44. According to one arrangement, the mold 44 comprises several extractors 50 distributed over the laying surface 42.

According to one embodiment, the polymerization or consolidation tool comprises a clamping system 52 for pressing the flanges 38.2, 38.3 of the profiles 38 against each other.

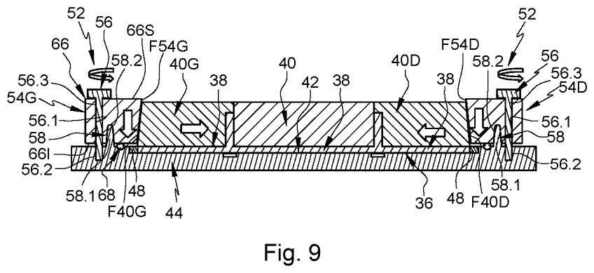

As shown in FIGS. 8 and 9, the polymerization or consolidation tool comprises first and second end mandrels 40D and 40G between which all the other mandrels 40 are positioned, each of the first and second end mandrels 40D, 40G having a free lateral end face F40D and F40G not in contact with another mandrel 40. According to one embodiment, unlike the lateral faces 40.3, 40.4 which are substantially perpendicular to the laying surface 42, the two lateral end faces F40D and F40G are inclined and each form an angle of 5° to 20° with a plane perpendicular to the laying surface 42. These two lateral end faces F40D and F40G have opposing angles of inclination such that the two lateral end faces F40D and F40G move apart as they approach the laying surface 42.

Additionally, the clamping system 52 comprises at least first and second flanges 54D, 54G, positioned on the two sides of the mandrels 40, having first and second contact faces F54D, F54G in contact with the two lateral end faces F40D and F40G, respectively. These contact faces F54D and F54G are inclined with respect to a plane perpendicular to the laying surface 42 by an angle identical to the angle of inclination of the two lateral end faces F40D and F40G, the contact faces F54D and F54G having angles of inclination such that the contact faces F54D and F54G move apart as they approach the laying surface 42.

According to one arrangement, the clamping system 52 comprises, for each end mandrel 40D, 40G, a single flange 54D, 54G which has a length substantially equal to the end mandrels 40D, 40G. According to another arrangement, the clamping system 52 comprises, for each end mandrel 40D, 40G, at least two flanges 54D, 54G distributed along each of the end mandrel 40D, 40G.

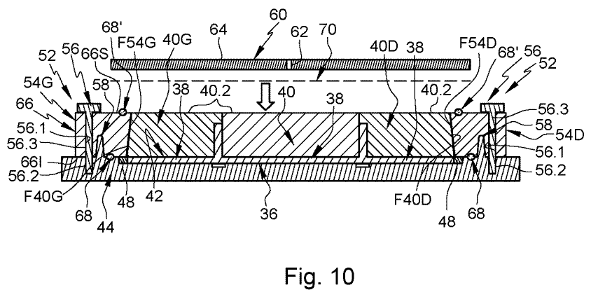

The clamping system 52 also comprises, for each first or second flange 54D, 54G, a tightening system 56 designed to connect the first or second flange 54D, 54G to the mold 44 and to gradually bring it closer to the mold 44. According to an arrangement visible in FIGS. 9 and 10, the tightening system 56 comprises a smooth hole 56.1 passing through each first or second flange 54D, 54G, a threaded hole 56.2 provided in the mold 44 and a screw 56.3 that is seated in the smooth hole 56.1, screwed into the threaded hole 56.2 and has a head bearing against the first or second flange 54D, 54G.

The clamping system 52 additionally comprises, for each first or second flange 54D, 54G, a guide system 58 designed to guide the first or second flange 54D, 54G relative to the mold 44 in a direction substantially perpendicular to the laying surface 42. According to one arrangement, the guide system 58 comprises at least one projecting form 58.1 integral with the mold 44 and at least one hollow form 58.2 (visible in FIG. 9), in the first or second flange 54D, 54G, designed to cooperate with the projecting form 58.1 so as to enable the first or second flange 54D, 54G to slide in a direction substantially perpendicular to the laying surface 42 as it approaches the mold 44.

According to one arrangement, after the first and second flanges 54D, 54G have been installed, the contact faces F54D, F54G are positioned in line with the packing shims 48 provided on the two sides of the skin 36.

The operating principle of the clamping system 52 is described with reference to FIG. 9. Once all the mandrels 40, 40D, 40G are positioned on the skin 36, the first and second flanges 54D, 54G are positioned so that the first and second contact faces F54D, F54G face respectively the first and second lateral end faces F40D and F40G and the hollow forms 58.2 thereof cooperate with the projecting forms 58.1 of the mold 44. The tightening systems 56 are then positioned and tightened. This tightening moves the first and second flanges 54D, 54G of the mold 44 closer together, thereby compacting the mandrels 40, 40D, 40G against one another. Once the tightening systems 56 have been tightened, the mandrels 40, 40D, 40G are held stationary with respect to each other and with respect to the mold 44, and are pressed against each other.

Of course, the invention is not limited to this embodiment of the clamping system 52. Other solutions can be envisaged to keep the mandrels 40, 40D, 40G stationary and pressed against each other.

The polymerization or consolidation tool comprises at least one sealing barrier 60 designed to form, with at least the mold 44, a substantially sealed enclosure in which the skin 36 and the profiles 38 are positioned during the polymerization or consolidation step. Additionally, the polymerization or consolidation tool comprises at least one gas extraction system which has at least one duct 62 opening into the enclosure delimited by the sealing barrier 60. According to one arrangement, the duct 62 is provided in the mold 44. According to another arrangement visible in FIGS. 5 and 6, the duct 62 passes through the sealing barrier 60.

According to an embodiment visible in FIG. 4, the sealing barrier 60 comprises a flexible membrane sealingly connected to the mold 44 and entirely surrounding the mandrels 40. This solution is more particularly suitable when the polymerization or consolidation tool comprises a mold 44 which comprises a base 44.1 and a frame 44.2 made in one piece and forming the seat 46 dimensioned to receive the skin 36 and all the mandrels 40. In this case, the enclosure in which the skin 36 and the profiles 38 are positioned is delimited by the mold 44 and the flexible membrane.

According to another embodiment visible in FIGS. 5 and 6, the sealing barrier 60 comprises a rigid plate 64 sealingly connected to the first and second flanges 54D, 54G. According to this embodiment, the enclosure in which the skin 36 and the profiles 38 are positioned is delimited by the mold 44, the first and second flanges 54D, 54G and the sealing barrier 60.

According to one arrangement, the first and second flanges 54D, 54G are interconnected to form a frame 66 which surrounds the mandrels 40, 40D, 40G and has a lower face 66I oriented toward the mold 44 as well as an upper face 66S opposite the lower face 66I and substantially parallel to the latter. According to this arrangement, the second faces 40.2 of the mandrels 40, 40D, 40G are substantially coplanar with the upper face 66S of the frame 66.

According to the embodiment visible in FIGS. 5 and 6, the sealing barrier 60 comprises a rigid plate 64 which has a peripheral edge overlapping the frame 66, at least one first gasket 68 interposed between the mold 44 and the frame 66, and at least one second gasket 68′ interposed between the frame 66 and the rigid plate 64.

Of course, the invention is not limited to these embodiments in order to form a sealing barrier 60 designed to delimit, with at least the mold 44, an enclosure in which the skin 36 and the profiles 38 are positioned.

According to one operating method, the method for manufacturing the stiffened panel 30 comprises, before the polymerization or consolidation step, a step of laying a sealing barrier 60 designed to form, with at least the mold 44, a substantially sealed enclosure in which the skin 36 and the profiles 38 are positioned.

Beforehand, the manufacturing method comprises a step of laying a frame 66 around the mandrels 40, 40D, 40G in order to immobilize them with respect to the mold 44, said frame 66 being sealingly connected to the mold 44, and a step of laying a rigid plate 64 sealingly connected to the frame 66 to form the sealing barrier 60.

According to an embodiment visible in FIGS. 5, 6 and 10, if the gas extraction system comprises at least one duct 62 passing through the rigid plate 64 of the sealing barrier 60, the polymerization or consolidation tool comprises a drainage layer 70 interposed between the rigid plate 64 and the mandrels 40, 40D, 40G.

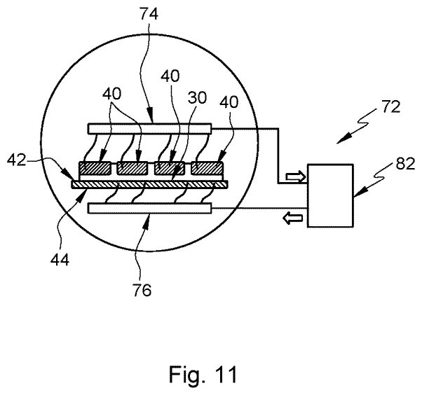

According to an embodiment visible in FIG. 11, the polymerization or consolidation tool comprises at least one temperature regulation system 72 for at least one mandrel 40 and/or for the mold 44.

According to one arrangement, the temperature regulation system 72 comprises at least one first fluid circuit 74, in which a first heat-transfer fluid circulates, positioned at least partially in at least one mandrel 40, 40A, 40B in order to regulate the temperature thereof and the temperature of the profile 38 attached thereto and/or at least one second fluid circuit 76, in which a second heat-transfer fluid circulates, positioned at least partially in the mold 44 in order to regulate the temperature thereof and the temperature of the skin 36 attached thereto.

As illustrated in FIG. 6, the rigid plate 64 of the sealing barrier 60 comprises, for each mandrel 40, 40D, 40G, at least one through-orifice 78 to allow the first fluid circuit 74 to pass through, as well as a ring gasket 80, surrounding the through-orifice 78, interposed between the rigid plate 64 and one of the mandrels 40, 40D, 40G.

According to one arrangement, the temperature regulation system 72 comprises at least one exchanger 82, such as a heat pump, designed to ensure heat exchanges between the first and second heat-transfer fluids. According to one operating mode, the first heat-transfer fluid is used to heat the second heat-transfer fluid.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A method for manufacturing a stiffened panel obtained from a plurality of profiles, each profile having a base and at least one flange, and a skin having first and second faces, the bases of the profiles being pressed against the first face of the skin, the flanges the profiles being pressed together in pairs, the method comprising:
obtaining the profiles;
positioning each of the profiles on a mandrel; and,
polymerizing or consolidating the profiles and the skin to obtain a stiffened panel,
wherein before the polymerizing or consolidating, the skin is laid on a laying surface of a mold comprising a seat in which at least the skin is positioned, the second face of the skin being pressed against the laying surface, and
wherein before the polymerizing or consolidating, mandrels are laid on the skin, the bases of the profiles being positioned against the skin, wherein, prior to laying the mandrels, the seat is delimited by a peripheral edge and dimensioned to leave a gap between the skin and the peripheral edge, and
wherein a packing shim is laid to fill the gap between the skin and the peripheral edge of the seat.

2. The method according to claim 1, wherein before the polymerizing or consolidating, a sealing barrier is laid, the sealing barrier designed to form, with at least the mold, a substantially sealed enclosure in which the skin and the profiles are positioned.

3. The method according to claim 2, further comprising:
laying a frame around the mandrels in order to immobilize the mandrels with respect to the mold, said frame being sealingly connected to the mold; and
laying a rigid plate sealingly connected to the frame to form the sealing barrier.

4. A tool for polymerization or consolidation in implementing a method manufacturing a stiffened panel, the tool comprising:
a plurality of mandrels, each mandrel configured to receive a profile;
a mold including a seat delimited by a bottom and a peripheral edge, the seat configured to receive at least one skin, said bottom forming a laying surface on which the at least one skin is laid; and,
at least one packing shim designed to fill a gap between the at least one skin and the peripheral edge of the seat.

5. The tool according to claim 4, further comprising:
a sealing barrier forming, with at least the mold, a substantially sealed enclosure in which the at least one skin and the profiles are positioned.

6. The tool according to claim 5, further comprising:
a frame configured to be positioned around the plurality of mandrels and to immobilize the plurality of mandrels with respect to the mold,
wherein the sealing barrier comprises a rigid plate which has a peripheral edge overlapping the frame, at least one first gasket interposed between the mold and the frame, and at least one second gasket interposed between the frame and the rigid plate.

7. The tool according to claim 4, further comprising:
first and second end mandrels of the plurality of mandrels between which all other mandrels of the plurality of mandrels are positioned, each of the first and second end mandrels having an inclined free lateral end face, the inclined free lateral end faces moving apart as the inclined free later end faces approach the laying surface; and,
a clamping system comprising at least first and second flanges, positioned on two sides of the plurality of mandrels, having first and second contact faces in contact with the two inclined free lateral end faces, respectively, the first and second contact faces moving apart as said faces approach the laying surface.

8. The tool according to claim 7, wherein the first and second flanges are connected together so as to form a frame.

9. The tool according to claim 7, wherein the clamping system comprises, for each first or second flange, a tightening system configured to connect the said flange to the mold and to gradually bring said flange closer to the mold.

10. The tool according to claim 7, wherein the clamping system comprises, for each first or second flange, a guide system configured to guide said flange relative to the mold in a direction substantially perpendicular to the laying surface.

11. The tool according to claim 4, further comprising:
at least one temperature regulation system for at least one mandrel, or the mold, or both.
